(19) United States
(12) Patent Application Publication
(10) Pub. No.: US 2006/0107852 A1
(43) Pub. Date: May 25, 2006

(54) Printing unit convertible between at least two printing modes

(75) Inventor: Marcel Motard, Laval (CA)

Correspondence Address: OGILVY RENAULT LLP, 1981 MCGILL COLLEGE AVENUE, SUITE 1600, MONTREAL, QC, H3A2Y3, CA

(73) Assignee: RDP MARATHON INC.

(21) Appl. No.: 11/044,719

(22) Filed: Jan. 28, 2005

Related U.S. Application Data
(63) Continuation of application No. 10/765,082, filed on Jan. 28, 2004, now abandoned.
Application No. 10/765,082 is a continuation of application No. 10/765,083, filed on Jan. 28, 2004, now Pat. No. 7,011,022.

(51) Int. Cl. B41F 11/00

(52) U.S. Cl. 101/142; 101/479

(57) ABSTRACT

A printing unit convertible between at least two printing modes comprising at least two interchangeable sets of cooperating printing cylinders. A first set of the cooperating printing cylinders includes a lithographic plate cylinder and a blanket cylinder and a second set of the cooperating printing cylinders includes an anilox cylinder and a flexographic plate cylinder. A selected one of the first and second sets is removably mounted in the printing unit with the cooperating printing cylinders thereof in rotatable contact with each other. The first set being selected to operate in an offset lithographic printing mode and the second set being selected to operate in a flexographic printing mode.

### CROSS-REFERENCE TO RELATED APPLICATION

This application claims priority on U.S. patent application Ser. No. 10/765,082 entitled “Rolling Element Adjustment System”, filed on Jan. 28, 2004, and U.S. patent application Ser. No. 10/765,083 entitled “Offset Printing Press Unit with Removable Cylinders”, filed on Jan. 28, 2004, and which are hereby incorporated by reference.

### BACKGROUND OF THE INVENTION

1) Field of the Invention

The invention relates generally to printing presses, particularly offset lithographic and flexographic printing presses, and to printing units convertible between different printing modes.

2) Description of the Prior Art

Offset lithographic printing presses are well known in the art. Typically, water and ink are supplied to a lithographic plate cylinder, and are then transferred to a blanket cylinder for printing onto sheets or a web, fed between the blanket cylinder and an impression cylinder. The water supply to the plate cylinder usually comprises a dampening unit having a dampening form roller which contacts the plate cylinder and is fed water from a water pan through intermediate water transferring rollers. Similarly, an inking unit transfers ink from an ink supply to the plate cylinder through ink transfer and application rollers. The printing pattern is defined by areas of the plate cylinder which are ink receptive, and others areas that are water receptive. The created pattern is transferred to the blanket cylinder which has a resilient outer surface configured to print a clear pattern onto the web or sheets. Due to the printing pattern exchange between the cylinders, the blanket cylinder and the plate cylinder are of the same external diameter and rotate at the same speed.

The line of contact between two cylindrical rollers in contacting engagement, otherwise known as the contact stripe, is a parameter determining printing quality. Standard adjustment mechanisms between rollers and cylinders include mechanical means such as bolts or screws and single pneumatic actuators, to allow fine tuning of the contact stripe between, for example, the inking or dampening form roller and the plate cylinder.

Presses have fixed lateral dimensions, and as such printed products wider than the length of the cylinders cannot be produced. Likewise, the circumference of the rotating cylinders determines the length of each repeated pattern being printed onto the web or sheets passing therethrough. Accordingly, the larger the circumference of the plate and blanket cylinders being used, the longer the printed pattern that can be produced. Therefore, in order for a press to print different sized “repeats” (each repeated pattern that is printed onto the web for each revolution of the cylinders), it is desirable to be able to use plate and blanket cylinders of various circumference.

It has been know to provide an offset press with a removable cylinder cartridge, having at least the plate and blanket cylinders mounted therein. For such a cartridge to be removed from the rest of the printing press, the cylinders must be disengaged from one another, and the entire cartridge slid out as a single unit from the frame of the press. A replacement cartridge having therein plate and blanket cylinders of a smaller or larger circumference is then inserted into the press in place of the original cartridge. This therefore permits the press to be converted to change the size of the repeat produced with each rotation of the press cylinders. While this solution provides the press with repeat rate variability, each cartridge is large and costly, and therefore the practical range of flexibility is generally limited by the cost and space considerations of keeping many different cartridges having cylinders of various sizes.

While individual cylinder removal would be more convenient, the removal of the cylinders requires them to be disengageable from each another, thus the precisely set contact stripe between the cylinders is lost. The set up time required once new cylinders are installed is therefore considerable. Further, this typically also requires that the intermeshed gears driving the cylinders be completely disengaged from each other every time a cylinder is to be removed. A known way to avoid this problem is to completely replace the gear train by drive motors used to drive the cylinders at the necessary speeds. Particularly, some presses employ a drive motor for each cylinder, thereby circumventing the requirement of gear trains completely. However, printing presses which are completely driven by servo drive systems are more expensive and more complex than those which use traditional gear train drives. Further, if any of the drive motors are incorrectly set or malfunction, the resultant mismatch in cylinder speeds can cause defective printed product or damage to the press.

Stand alone flexographic printing presses are also well known in their own right, and differ substantially enough from offset lithographic presses to be used for different types of processes. Typically, flexographic presses include a small diameter anilox roller that receives a quantity of ink from a metering roller, the excess of which is removed by a doctor blade. The anilox roller is commonly laser engraved, and thus covered with small cavities which carry the ink evenly to a flexographic plate cylinder which has a large outer circumference made of a resilient material. The printing pattern is defined by protruding and recessed areas defined in the resilient material of the flexographic plate cylinder. Ink is received by the protruding areas, and the printing pattern is transferred onto the web or sheet. To achieve repeat rate variability, the size of the flexographic plate cylinder is varied, whereas the anilox roller is not changed.

Offset lithographic and flexographic printing presses are generally complementary, since they produce different types of printed products and are employed for different applications. The two different types of presses are sometimes combined sequentially in printing processes to obtain specific results. The cost of both types of printing presses, and the space each occupies in a printing shop is significant. This causes some printing shops to opt for one or the other, and consequently, to offer only one of these types of printing modes to their clients.

While attempts have been made to provide a single printing press that can be operate in either of these two printing modes, the resulting presses have been largely impractical and unsuccessful in achieving an efficient, cost effective and reliable convertible printing press.

U.S. Pat. No. 5,629,363 discloses a convertible press having a lithographic plate cylinder and a blanket cylinder, thus providing an offset lithographic printing mode. The press can be converted to flexographic printing mode. To achieve this, the lithographic plate cylinder is disengaged, and a resilient flexographic plate sleeve with the desired printing pattern is slipped around the blanket cylinder. Then, an anilox roller mounted on a printing head which is part of a pivotal arm assembly, is pivoted down from its stored position on the top of the press frame and engaged into contact with the flexographic sleeve. The many components of the pivotal arm assembly are costly. Further, the position in which it the anilox roller is engaged severely limits the access to the anilox cylinder when in operation. This is especially true because of the combined obstruction caused by the unused lithographic plate cylinder. The type of press disclosed therein is of limited repeat rate variability.

U.S. Pat. No. 5,697,297 discloses a printing press adapted to receive interchangeable cassettes with components corresponding to different printing modes. To convert the press from one printing mode to another, a cassette unit containing the cylinders and components required in one mode is removed and replaced by a cassette containing the components required for the other mode. As described above, cassette units are quite bulky, and their storage and handling are quite cumbersome; especially to a printing shop that has limited storage possibilities. Further, each cassette includes not only the cylinders, but the cassette casing and cylinder driving components as well, thus their purchase is costly. These downsides greatly diminish the advantages of not having to buy an entire press for each process.

Due to the insufficiencies of the art, a there remains a need for an improved convertible printing press which allows for both offset lithographic and flexographic printing modes.

### SUMMARY OF THE INVENTION

It is an object of the invention to provide an improved printing press.

It is object of the invention is to provide a printing press convertible between offset lithographic and flexographic printing modes.

It is another object of the invention to provide a flexographic doctor blade adjustment mechanism that allows a doctor blade to maintain contact with an anilox cylinder regardless of the position of the anilox cylinder relative to the flexographic plate cylinder.

One aspect of the present invention provides a printing unit convertible between at least two printing modes comprising at least two interchangeable sets of cooperating printing cylinders, a first set of said cooperating printing cylinders including a lithographic plate cylinder and a blanket cylinder and a second set of said cooperating printing cylinders including an anilox cylinder and a flexographic plate cylinder, wherein a selected one of said first and second sets is removably mounted in said printing unit with the cooperating printing cylinders thereof in rotatable contact with each other, said first set being selected to operate in an offset lithographic printing mode and said second set being selected to operate in a flexographic printing mode.

Another aspect of the invention provides a printing unit convertible between offset lithographic and flexographic printing modes comprising: an ink cylinder selected from one of a lithographic plate cylinder and an anilox cylinder, said ink cylinder being removably mounted in said printing unit and having an outer surface of a diameter corresponding to a selected repeat rate and which is adapted to receive ink thereon, said ink cylinder being removable from said printing unit and interchangeable with the other of said lithographic plate cylinder and said anilox cylinder; a print cylinder selected from one of a blanket cylinder and a flexographic plate cylinder, said print cylinder being removably mounted in said printing unit in rotatable contact with said ink cylinder and having an outer surface of said diameter which is adapted to receive ink from said ink cylinder, said print cylinder being adapted for contact with a printable substrate for printing thereon, said print cylinder being removable from said printing unit and interchangeable with the other of said blanket cylinder and said flexographic plate cylinder; and wherein said lithographic plate cylinder and said blanket cylinder cooperate to define said offset lithographic printing mode and said anilox cylinder and said flexographic plate cylinder cooperate to define said flexographic printing mode.

Another aspect of the invention provides a method of converting a printing unit from one of a flexographic and offset lithographic actual printing mode to the other desired mode comprising: interchanging an ink cylinder of said printing unit corresponding to said actual mode by a replacement ink cylinder corresponding to said desired mode, said ink cylinder being an anilox cylinder for said flexographic printing mode and a lithographic plate cylinder for said offset lithographic printing mode; and interchanging a print cylinder of said printing unit corresponding to said actual mode by a replacement print cylinder corresponding to said desired mode, said print cylinder being a flexographic plate cylinder for said flexographic printing mode and a blanket cylinder for said offset lithographic printing mode.

Another aspect of the present invention provides a enclosed doctor blade mounting assembly for a printing unit operable in at least a flexographic printing mode in which an anilox cylinder is displaceable between an engaged and a disengaged positions along an displacement path, said mounting assembly comprising: at least one mounting member engaged to a frame portion of said printing unit via at least one displacement guide, said displacement guide being orientated to correspond to said displacement path, said mounting member having a pivot joint; and at least one linking member rotatable about an axis of said anilox cylinder, the linking member having a link pivot joint at a substantially peripheral location pivotally engaged with said mounting member at said pivot point thereon; wherein said enclosed doctor blade is held in abutting contact with said anilox cylinder within said mounting assembly, and maintained in said abutting contact in at least both of said engaged and disengaged positions, said linking member being displaced along said displacement path by said anilox cylinder and said linking member displacing said mounting member, which carry said enclosed doctor blade, along said displacement guide.

Another aspect of the invention provides a convertible printing unit that can be converted between offset lithographic and flexographic printing modes by interchanging its offset lithographic plate cylinder with an anilox cylinder, and interchanging its blanket cylinder with a flexographic plate cylinder. The anilox and flexographic plate cylinders have the same external diameter. When converting the unit from offset lithographic to flexographic, at least one ink and one dampening form rollers are disengaged from the lithographic plate cylinder. Once the offset lithographic cylinders have been interchanged with flexographic cylinders, an enclosed doctor blade is mounted to the unit frame via a mounting assembly that automatically maintains abutting contact of the enclosed doctor blade with the anilox cylinder regardless of whether the latter is engaged or disengaged from the flexographic plate cylinder. The drive mechanism is adapted to drive the anilox cylinder in either position. Only cylinder sleeves may be interchanged instead of entire cylinders.

In the present specification, the term print cylinder is used generically with reference to the function of applying ink to a sheet or web in either one of flexographic and offset lithographic printing modes, and encompasses both the blanket cylinder used in offset lithographic printing mode, and the flexographic plate cylinder used in flexographic printing mode. Similarly, the term ink cylinder refers to the function of transferring ink to the print cylinder in either mode, and encompasses both the lithographic plate cylinder and the anilox cylinder.

Furthermore, the term web as used throughout the specification includes any type of printable material, and can include webs, sheets or other printable substrates suitable for use with a printing press.

### BRIEF DESCRIPTION OF THE DRAWINGS

Further features and advantages of the present invention will become apparent from the following detailed description, taken in combination with the appended drawings, in which:

FIG. 1 is a schematic side elevation view of a serial arrangement of two presses, each of which includes a convertible printing unit in accordance with a preferred embodiment of the present invention; one printing press is operating in offset lithographic printing mode, and the other printing press is operating in flexographic printing mode;

FIG. 2 is a schematic side elevation view, enlarged, of a convertible printing press in offset lithographic printing mode, in accordance with an embodiment of FIG. 1, showing more particularly the form rollers of the press, and the rolling element adjustment system of the rollers;

FIG. 3A is a schematic side elevation view of a convertible printing unit in accordance with the embodiment of FIG. 2, and showing the rolling element adjustment system for the impression cylinder;

FIG. 3B is a schematic side elevation view of a convertible printing unit in accordance with the embodiment of FIG. 2, showing operation at a different repeat rate than depicted in FIG. 3a;

FIG. 4 is a front elevation view, partly sectioned, of a convertible printing unit in accordance with the embodiment of FIG. 1, showing more particularly the sleeve changing components;

FIG. 5 is a partial perspective view of a convertible printing unit in accordance with the embodiment of FIG. 1, showing the gearing system adapted to different repeat rates;

FIG. 6 is a schematic side elevation view, enlarged, of a convertible printing unit in flexographic mode, in accordance with an embodiment of FIG. 1, showing more specifically the enclosed doctor blade mounting assembly;

FIG. 7 is a top view, enlarged and partly sectioned, of the enclosed doctor blade mounting assembly of FIG. 6;

FIG. 8A is a schematic side elevation view of a convertible printing unit in flexographic mode, showing the impression cylinder positioning shaft; and

FIG. 8B is a schematic side elevation view of a convertible printing unit in flexographic mode, having larger anilox and flexographic plate cylinders than the unit of FIG. 8A, and therefore having a larger repeat rate.

### DETAILED DESCRIPTION OF THE PREFERRED EMBODIMENT

In reference to the drawings, it will be seen that the one embodiment of the present invention provides a printing unit 10 convertible between offset lithographic and flexographic printing modes wherein the convertibility is at least partly provided by the interchangeability of the cylinders corresponding to one mode with those corresponding to the other. In the preferred embodiment, the convertible printing unit is provided as a removable insert 15 which is separable from a press main body, and may be assembled or disassembled therewith. However, the convertible printing unit 10 of the invention may alternatively be provided directly in the fixed frame of a printing press, without being disposed in a removable insert. Due to this possible alternative, the term “convertible printing unit” as used herein is intended to refer generally to the unit which includes the rotating components of the invention, and include both the term “convertible printing press” when embodied as such, and the term “convertible printing insert” when embodied as such. In both cases, the convertible printing unit allows conversion from one mode to the other.

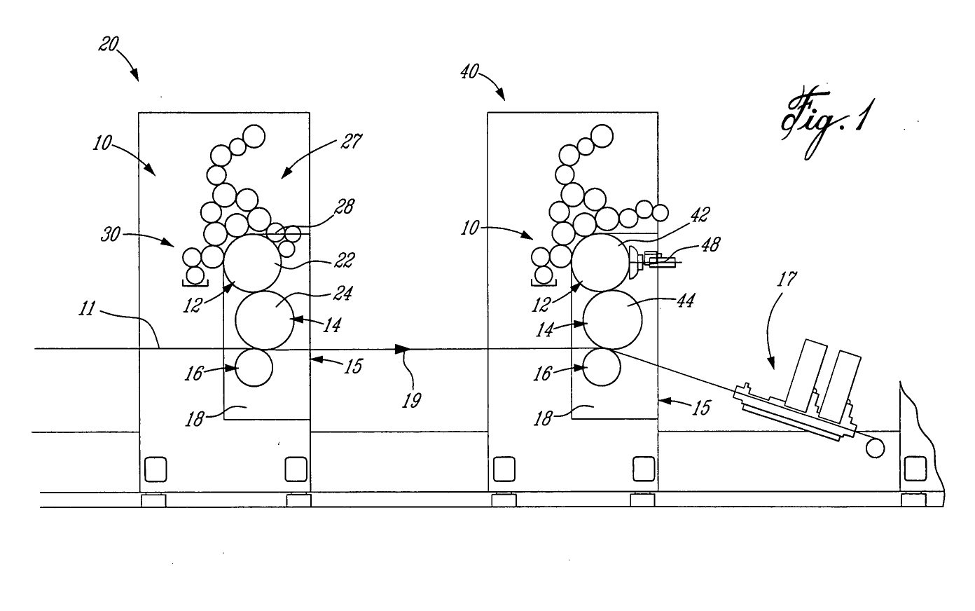

FIG. 1 illustrates a preferred embodiment of the invention where two convertible printing units 10 are provided in removable inserts 15 installed onto a main press frame, and are illustrated in serial arrangement. As discussed, the convertible printing units 10 can alternately be provided directly in a press frame without any removable inserts. One convertible printing unit 10 is shown operating in offset lithographic printing mode 20, and the other convertible printing unit 10 is shown operating in flexographic printing mode 40. In either printing mode, and whether provided as an insert or as a press, each printing unit 10 has two parallel, spaced-apart frame side portions, an ink cylinder 12 and a print cylinder 14 of the same diameter, as well as an impression cylinder 16. All three cylinders have each end rotatably mounted to an opposite frame side 18. Ink is received by the ink cylinder 12, which transfers it to the print cylinder 14. The ink is then printed in the desired printing pattern onto a printable substrate 11 such as a web or sheet. The web 11 is engaged between the print 14 and impression 16 cylinders. In offset lithographic printing mode 20, the ink is preferably provided to the ink cylinder 12 by at least one ink form roller 28, whereas in flexographic printing mode 40, the ink is preferably provided to the ink cylinder 12 by an enclosed doctor blade 48. The enclosed doctor blade 48 is also called a chambered doctor blade, and although the appellation “enclosed doctor blade” is preferred in the present text, chambered doctor blade is intended to be included within the meaning of this term. In FIG. 1, the two convertible printing units are depicted in serial arrangement for the purpose of illustration and comparison, and for illustrating a possible arrangement of successive printing units. It is to be understood that both units are convertible between offset lithographic and flexographic printing modes, and may be used individually, as well as in any other suitable arrangement and combination. For example, a series of successive printing units all operating in flexographic print mode 40, a series of successive printing units all operating in offset lithographic printing mode 20, or a series of such printing units operating in any combination of both printing modes may therefore be possible. The type of printing mode employed with be selected based on the type of printed product being produced and the particular application required.

As it is apparent in FIG. 1, each mode 20, 40 has an impression cylinder 16 rotatably mounted to the frame 18 on a first rotation axis. Furthermore, each mode 20, 40, equally has a print cylinder 14 and an ink cylinder 12 of equal diameter, each rotatably mounted to the convertible unit frame 18 on second and third rotation axes, respectively. In offset lithographic mode 20, the print 14 and ink 12 cylinders selected are a blanket cylinder 24, and a lithographic plate cylinder 22, respectively. In flexographic mode 40, the print 14 and ink 12 cylinders are a flexographic plate cylinder 44 and an anilox cylinder 42, respectively. Hence, the print cylinder 14 and the ink cylinder 12 corresponding to one actual mode are interchanged selectively with those corresponding to the other desired mode as part of the conversion process of the printing unit from that one mode to the other. The web or sheet 11 of material to be printed is driven between the impression cylinder 16 and the print cylinder 14 during printing operation. The first, second and third rotation axes, corresponding to the impression, printing, and ink cylinders, respectively, are preferably precisely parallel to each other and a precise contact stripe is set between the contacting cylinders.

In FIG. 1, it is apparent that the web 11 follows a path in the indicated web direction 19 that is straight through the offset lithographic mode 20, and angled through the flexographic mode 40. In fact, the web path is not completely straight through the offset lithographic mode 20: the web first wraps slightly around the impression cylinder 16, and then wraps slightly around the blanket cylinder 24. This is allowable, even desired, in offset lithographic mode 20. However, wrapping of the web around the flexographic plate cylinder 44 in flexographic printing mode 40 is not desired, because the resilient nature of the flexographic plate cylinder 44 outer surface has been known to produce smudging of the ink pattern on the web when so wrapped. The angled portion of the web 11 coming out of the flexographic printing mode 40, and through a dryer 17, is the preferred configuration designed to avoid wrapping of the web around the flexographic plate cylinder 44. The selected inclination avoids wrapping the flexographic plate cylinder 44, while maintaining a precise contact stripe. However, changing the cylinder disposition, for example, could provide alternative means of avoiding such wrapping of the web.

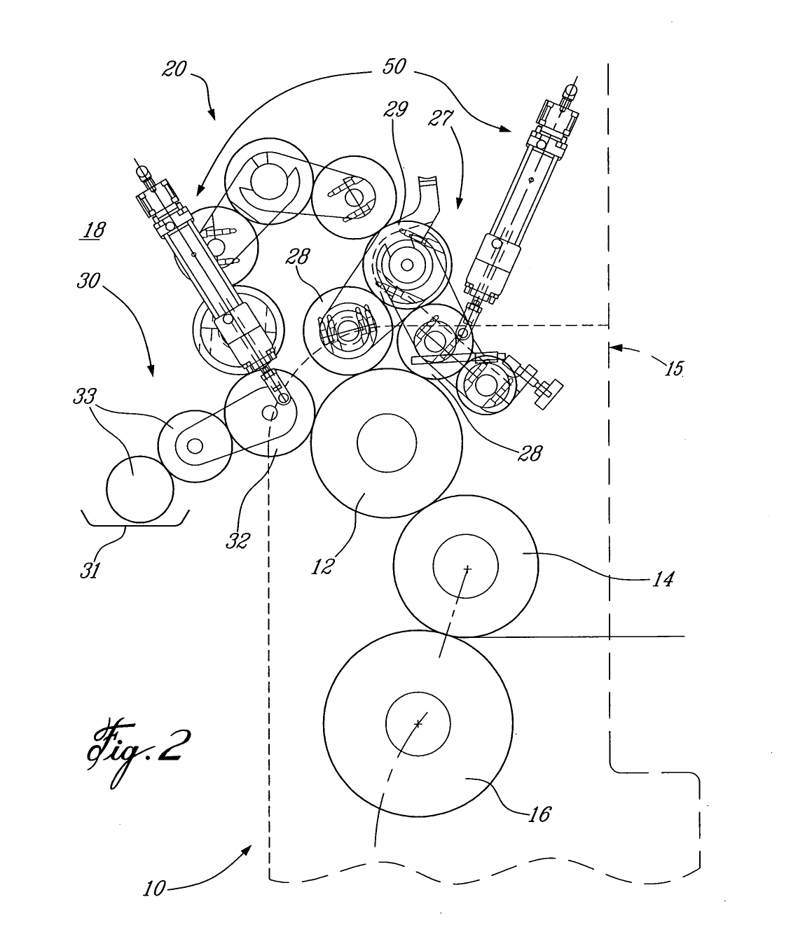

In both printing modes 20, 40, the convertible printing unit 10 is illustrated in operation, with cylinders engaged to one another. In offset lithographic mode 20, ink and a dampening fluid are supplied to the offset lithographic plate cylinder 22 by an inking 27 and a dampening 30 units, respectively. Whereas in flexographic printing mode 40, the inking 27 and dampening 30 units are disengaged from the ink cylinder 12. It will be seen, with reference to both U.S. patent application Ser. No. 10/765,082 and Ser. No. 10/765,083, incorporated by reference herein, that the preferred offset lithographic unit configuration has been found to be particularly advantageous over many prior art systems due to several adaptations. These adaptations are now used in flexographic mode 40, according to the present invention. These adaptations are discussed with reference to FIGS. 2, 3, 4, and 5.

In offset lithographic mode 20, which is more clearly illustrated in FIG. 2, ink is provided to the ink cylinder 12 by ink form rollers 28, via an ink transfer roller 29, all of which are rotatably mounted to the press frame 18 and are engaged in rotary contact with one another. Likewise, a dampening fluid from a dampening supply 31 is picked up by dampening transfer rollers 33, and transferred to the lithographic plate cylinder 12 via a dampening form roller 32. Two form roller adjustment systems 50 allow the form rollers 28, 32 to be easily engaged and disengaged to and from the ink cylinder 12 at the unit shutdown and startup as part of the throw-off and throw-on sequence. In the instant specification, the term “throw-off” means disengaging a cylinder or a roller, or a combination of a number thereof, from one another. The form roller adjustment systems 50 also allow positioning of the form rollers 28, 32 in a way to adapt to different sizes of ink cylinders 12, which is helpful when using the convertible printing unit in offset lithographic printing mode. The form roller adjustment systems 50 and their functioning are further detailed and described in U.S. patent application Ser. No. 10/765,082, which is incorporate herein by reference.

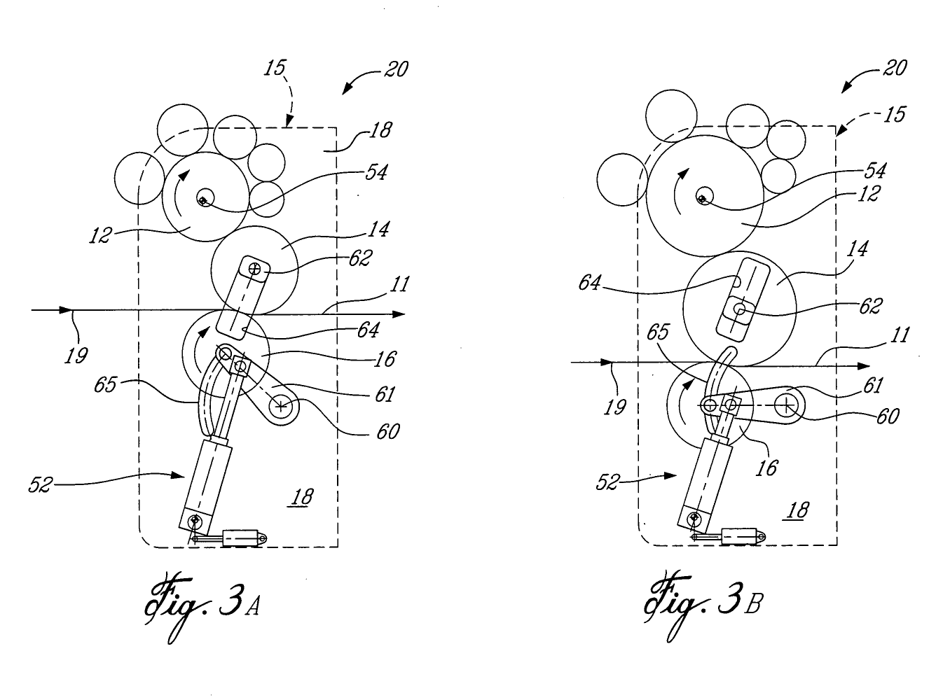

Now referring particularly to FIGS. 3a and 3b, an impression cylinder adjustment system 52, an alternative embodiment of the form roller adjustment system 50 of FIG. 2, is illustrated. The impression cylinder adjustment system 52 is adapted to easily throw-on and throw-off the impression cylinder 16 from the print cylinder 14, but is also adapted to adjust the position of the impression cylinder 16 to print cylinders 14 of various sizes. Thus, the impression cylinder 16 is easily thrown-off from the print cylinder 14 when printing is interrupted, and easily thrown-on when the press is re-started, without the operator having to precisely reset the contact stripe between these cylinders. In the preferred embodiment, the impression cylinder adjustment system 52 is used in both printing modes. However, it is to be noted that other systems to throw-on or throw-off form rollers 28, 32 and impression cylinder 16 may alternatively be used, depending on the application.

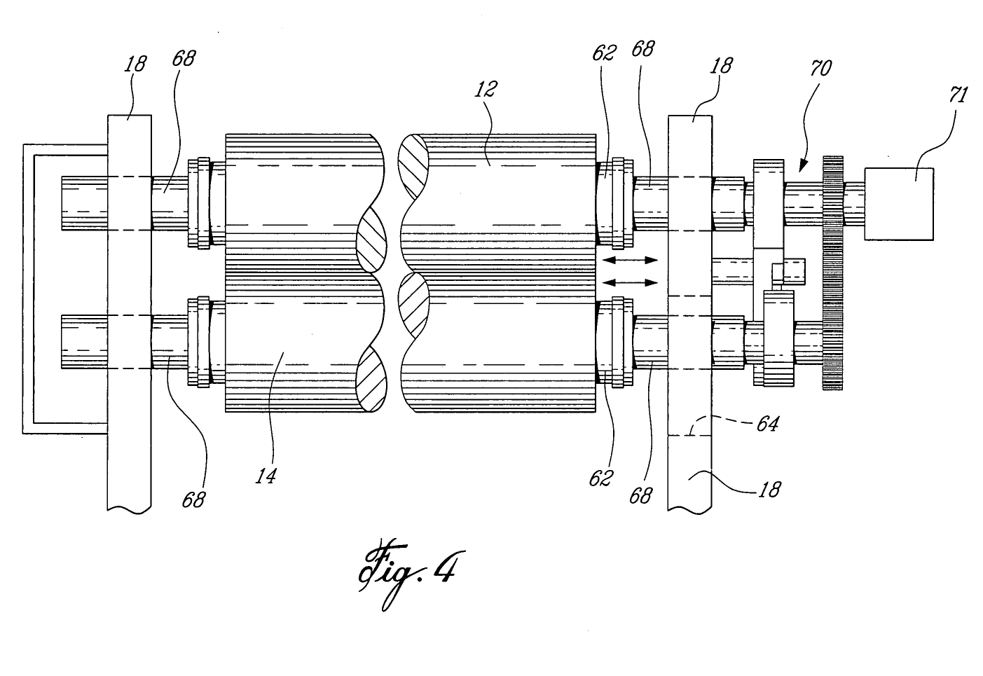

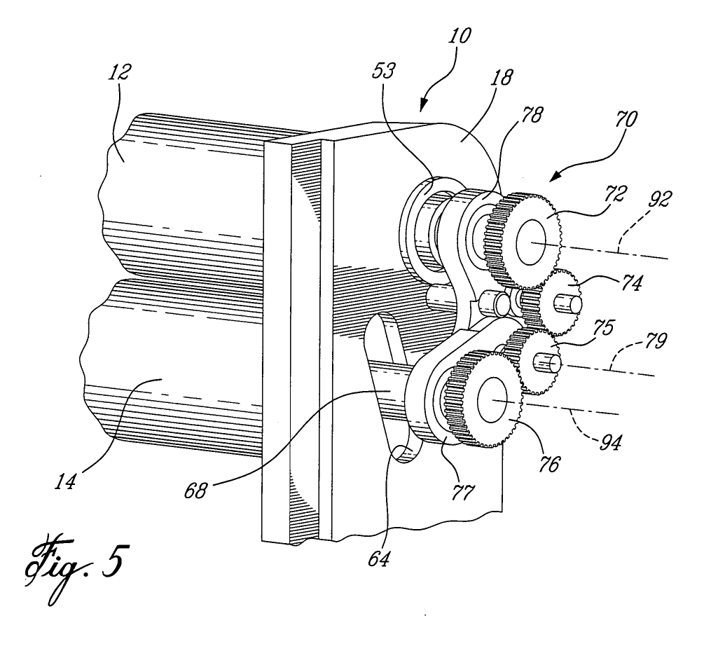

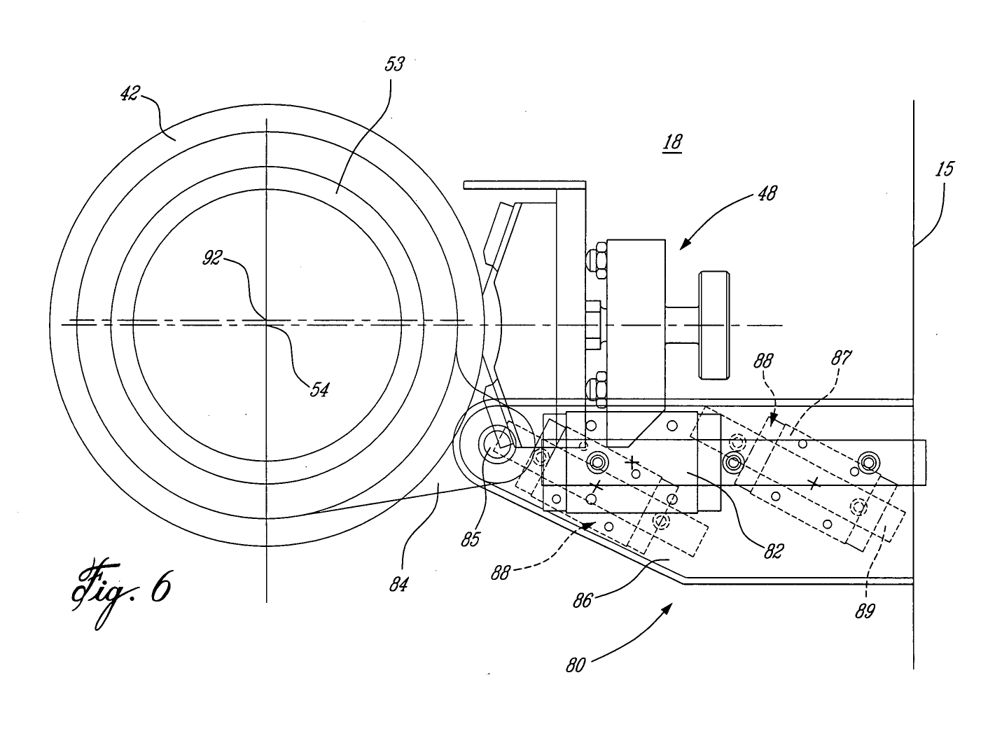

Each end of the ink cylinder 12 is preferably rotatably mounted to an opposite frame side 18 of the unit via an off-center bearing member 53 (FIG. 5), which is not translatable within the frame structure 18. However, the bearing members 53 are rotatable therewithin around a bearing axis 54 which is off-center relatively to the ink cylinder axis 92 (FIG. 6). Hence, each end of the ink cylinder 12 (preferably each trunnion 68, as will be described further on with reference to FIG. 4) is eccentrically engaged within an opposite bearing member 53, which can be rotated within the frame sides 18, by a suitable mechanism, and thereby displace the ink cylinder 12 from contacting engagement with the print cylinder 14 along an arc-shaped path around the off-center axis 54 to a throw-off position, or vice-versa. The path along which the ink cylinder 12 is removed from engagement with the print cylinder 14 will be referred to herein as the engagement path. The throw-off of the ink cylinder 12, combined with the throw-off of the previously mentioned impression cylinder 16 and form rollers 28, 32, permits the printing to be interrupted, and subsequently resumed, without the operator having to precisely re-adjust the contact stripe between the cylinders and/or rollers. Although the aforementioned bearing members 53 are the preferred type of engagement mechanism, other types thereof may alternatively be used and remain within the scope of the invention. Further, let us recall that although in the preferred embodiment the bearing members are installed in each frame side of a separable insert 15, the bearing members are installed directly within each frame side of the press main body in the embodiments where the insert 15 is omitted.

When stopping the preferred convertible printing unit 10 that is operating in offset lithographic mode 20, the preferred throw-off sequence is as follows: the form rollers 32, 28 are disengaged from the lithographic plate cylinder 22 first, and then both the impression cylinder 16 and lithographic plate cylinder 22 are disengaged from the blanket cylinder 24 at the same time. When the unit is shut down, all three of the offset lithographic plate 22, blanket 24 and impression 16 cylinders stop turning. FIGS. 3a and 3b both illustrate the convertible printing unit 10 in offset lithographic printing mode 20, but it will be seen that the engagement mechanism component will be of particular use when throwing off the printing unit 10 operating in flexographic mode. Also, please note that even though the impression 16 and ink 12 cylinders are preferably thrown-off in the preferred embodiment, alternative embodiments may choose other throw-off sequences, such as having the print cylinder 14 disengaging from both the ink 12 and impression 16 cylinders, for example, which would necessitate much adaptation and modification from the preferred embodiment herein described.

It can be seen that the particular configuration illustrated in FIG. 3a uses ink 12 and print 14 cylinders of a relatively small diameter, thus providing a high repeat rate. Oppositely, the configuration illustrated in FIG. 3b uses ink 12 and print 14 cylinders of a relatively large diameter, thus providing a low repeat rate, for a longer printed pattern to be produced. The impression cylinder 16 is preferably of fixed diameter, regardless of the size of print 14 and ink 12 cylinder diameter selected. It will be seen that for enabling the unit 10 to accommodate different sizes of printing 14 and ink 12 cylinders, the preferred embodiment provides for the print 14 and impression 16 cylinders to be displaced within each frame sides 18 by suitable displacement mechanisms.

The preferred impression cylinder displacement mechanism includes having each end of the impression cylinder 16 made thinner to extend through opposite arc-shaped slots 65 defined within each frame side 18. Each impression cylinder end is mounted to a positioning shaft 60, spaced apart from the impression axis and having an axis of rotation centered on the center of the arc-shaped slot 65, via a pivotal fixture 61. The positioning shaft 60 also extends through both frame sidings 18 to said fixture 61, parallel said impression cylinder 16. The impression cylinder 16 may thus be pivoted along the arc-shaped slot 65, with each end thereof following a corresponding slot 65. This ensures stability, and that both ends of the impression cylinder 16 are pivoted the same amount. The axis of rotation of the positioning shaft 60 is relatively spaced apart from that of the impression cylinder 16. Each end of the impression cylinder is rotatably mounted to the pivotal fixture for its rotation during operation, where the impression cylinder 16 is locked into engagement with the print cylinder 14 in a precisely set printing stripe. In addition to the described displacement of the impression cylinder 16 along the arc-shaped slot 65 to accommodate different sizes of cylinder, the arc-shaped slot 65 is also used in combination with the impression cylinder adjustment system 52 to slightly displace the impression cylinder 16 during the throw-off and throw-on sequence.

As it is also shown, the print cylinder 14 is also displaced to accommodate different sizes of cylinders. In fact, each preferred print cylinder displacement mechanism includes a guiding block 62 rotatably receiving each end of the print cylinder 14, and which extends through a lengthwise slot 64 defined within each frame side 18. Each end of the print cylinder 14 can therefore slide within the lengthwise slot 64 via the guiding block 62 to adapt to larger or smaller diameter of printing 14 and ink 12 cylinders. The print cylinder 14 is preferably rotatably mounted at each end within a guiding block 62, the latter being only translatable within the linear slot 64.

Hence, in the preferred embodiment, when interchanging the printing 14 and ink 12 cylinders with cylinders of a greater diameter, the impression cylinder is slid down arc-shaped slot 65, and the print cylinder is slid down linear slot 64, which accommodates the greater diameter of cylinder. The opposite movements are done when interchanging to smaller diameter cylinders. Although the preferred linear 64 and arc-shaped 65 slots arrangement described for displacing the print 14 and impression 16 cylinders to provide repeat rate adaptability has been found to be suitable in the preferred embodiment, especially with the preferred gearing mechanism, it is meant to be only illustrative of a preferred mode of realization. Therefore, any alternative type of repeat rate adaptability system, if any, may while remaining within the scope of the invention, including displacing any number of the three cylinders by any suitable displacement mechanism.

As previously discussed, the ink 12 and print 14 cylinders of common diameter are interchanged with ink 12 and print 14 diameters of greater or lesser common diameter to provide different repeat rates. To achieve this change of diameter, or to switch from one mode to the other as it will be discussed further on, it was up to now left unclear whether each printing 14 and ink 12 cylinder would be entirely removed and interchanged or if common components would remain. It has been found more desirable for many practical reasons to interchange only differently cylinder sleeves around fixed-diameter central mandrel shafts 62 to achieve essentially the same result.

The preferred components for achieving the sleeve change are best illustrated in FIG. 4. The components are similar for the ink 12 and print 14 cylinders, and so discussion will be made generically, as applying to both. The cylinder sleeves have a hollow center, which receives a central mandrel shaft 62 extending axially from both ends. The central mandrel shafts 62 themselves are disposed onto trunnions 68 which extend through the unit frame sides 18, and which support the sleeves and shafts. The trunnions 68 are the preferred cylinder ends which pass through the linear slots 64 defined in the frame side 18 in the case of the print cylinder 14, or are mounted within the bearing members 53 in the case of the ink cylinder 12. Removing and interchanging only the sleeves is preferred to changing entire cylinders because sleeves are generally found to be less bulky, less expensive, lighter, and therefore easier to store and to handle than entire cylinders. However, in certain applications it may nonetheless be preferred to remove entire cylinders. Since changing either the entire cylinder or only the cylinder sleeve achieves operatively the same result, the expression “changing the cylinder” is used throughout the present specification for simplicity, and is intended to include changing only sleeves rather than the entire cylinders. It will be understood, in the light of the present description, that the cylinders can be interchanged with cylinders of a different diameter of the offset lithographic printing mode, or, as it will be shown, with cylinders of various diameters corresponding to the flexographic printing mode 40. The presently described components are meant to be illustrative only of the preferred embodiment, as other ways to change the cylinder sleeves also fall within the scope of the invention.

FIG. 4 also illustrates a motor 71, preferably a servo motor, that drives both the ink 12 and print 14 cylinders via a gearing mechanism 70 in a one to one gearing ratio. The gearing mechanism 70 is more clearly depicted in FIG. 5. In the preferred embodiment, a single motor 71 drives the ink cylinder 12 of the printing unit 10, and the ink cylinder 12 is linked with the print cylinder 14 by a gearing mechanism 70, whereas the impression cylinder 16 is preferably driven by the unit main motor. The drive motor 71 can either be coaxially arranged with the plate cylinder (as shown in FIG. 4) or offset therefrom and interlinked by an idler gear. The gearing mechanism 70 comprises a print cylinder gear 76 and an ink cylinder gear 72, disposed on common ends of each respective cylinder 14, 12. First and second idler gears 74 and 75, intermeshed with each other and with the plate cylinder gear 72 and the blanket cylinder gear 76 respectively, complete the gear train between the two cylinders.

The drive linkage mechanism 70 comprises a first linkage arm 78 and a second linkage arm 80, relatively pivotal with respect to each other about a gearing pivot axis 79 which is not fixed to the press frame to allow lengthwise displacement of the linkage arms in addition to pivotal movement. Therefore, both linkage arms 78, 80 are pivoted relatively to each cylinder 12, 14 axis, respectively, and the gearing pivot axis 79 is displaced, either when the print cylinder 14 is displaced (along slot 64 in the preferred embodiment), or when the ink cylinder 12 is displaced (as when it is disengaged in the preferred embodiment). The gearing pivot axis is preferably coaxial with the shaft of the second idler gear 75 in meshing engagement with the blanket cylinder gear 76, but could alternatively be coaxial with the first idler gear 74, for example. The first linkage arm 78 is also pivotal about the ink cylinder axis 92 of the ink cylinder 12.

It will be noticed that the gears are so mounted with the linkage arms that they remain intermeshed regardless of the position of either linkage arm, and therefore independently of the sizes of cylinders used, or of the engagement or disengagement position of the ink cylinder 12. Therefore, with the preferred displacement and engagement mechanisms, the driving mechanism is adapted to drive the ink cylinder 12 even when the latter is disengaged from the print cylinder 14 by the rotary movement of bearing member 53. This characteristic will appear very interesting to those skilled in the art for it has an important function when using the unit in flexographic mode, as will be detailed later.

It will be noted that the preferred gearing mechanism is adapted to the preferred disengagement system (ink cylinder 12 via bearing member 53, and impression cylinder 16 via adjustment system 52), and is adapted to the cylinder diameter adjustment system (linear slot 64 and arc-shaped slot 65). If other types of disengagement or cylinder diameter adjustment systems are to be used, substantial adaptations may need to be provided to the gearing mechanism for it to operate accordingly. Therefore, the present gearing mechanism is meant to be only illustrative of a preferred mode of realization, and not a limitation to the invention.

The characteristics described with reference to FIGS. 2 to 5 were initially designed for an offset lithographic unit, and have been proven to be particularly efficient in providing a quality press having a high versatility of repeat rates, as well as being truly efficient of operation, especially when considering the throw-off and throw-on sequences. Such characteristics were not known to flexographic printing mode, and it has been found increasingly enticing to have access to these innovative characteristics first developed in relation to offset lithographic printing in the flexographic printing mode. That which has been achieved with the preferred embodiment is even more, for as it will appear, not only will it now be possible to use these innovative characteristics in flexographic printing mode, but it will also be possible to have access to both modes within a single printing unit, with all the additional advantages that are brought by this convertibility. The use of the printing unit in flexographic printing mode will now be detailed further.

In the offset lithographic driving mechanism, the cylinders 12 and 14 are driven by a servo motor 71 and linked together by a gear train. Known flexographic anilox rollers are of a fixed circumference, where it is the flexographic plate cylinder only that is changed for one of different diameter to achieve variance of repeat rate. In the present preferred embodiment, the flexographic plate cylinder 44 and anilox cylinder 42 are of the same diameter to one another, much as in the offset lithographic printing mode 20. They are thus adapted to be driven by the previously described gear train driving mechanism at a 1 to 1 gearing ratio. When variability of repeat rate is desired in flexographic mode 40, both the anilox 42 and flexographic plate 44 cylinders are changed to cylinders of different diameter, as described above. It has been determined that providing a number of anilox cylinder sleeves of different outer diameter corresponding to different outer diameters of a number of flexographic plate sleeves, to render the anilox 42 and flexographic plate 44 cylinders adapted to the ink 12 and print 14 cylinders of the convertible printing unit 10, is a relatively cost effective way to allow the afore-mentioned advantages with both printing modes, and permitting convertibility within a single printing unit.

Thus, to convert the press from offset lithographic mode 20 to flexographic mode 40, the offset lithographic mode is thrown-off and the lithographic plate 22 and blanket 24 cylinders (or sleeves) are removed as previously described. The blanket cylinder 24 is interchanged with a flexographic plate cylinder 44, and the lithographic plate cylinder 22 is interchanged with an anilox cylinder 42. For reasons detailed above, it is preferred to change only the cylinder sleeves using a common mandrel shaft for both modes and every size of cylinder used instead of changing the entire cylinders. As it was discussed, the print 14 and ink 12 cylinders are of the same diameter which corresponds to a predetermined repeat rate. It will now be possible to use the same gearing mechanism, as well as the same throw-off and cylinder size displacement mechanisms in both offset lithographic and flexographic printing modes.

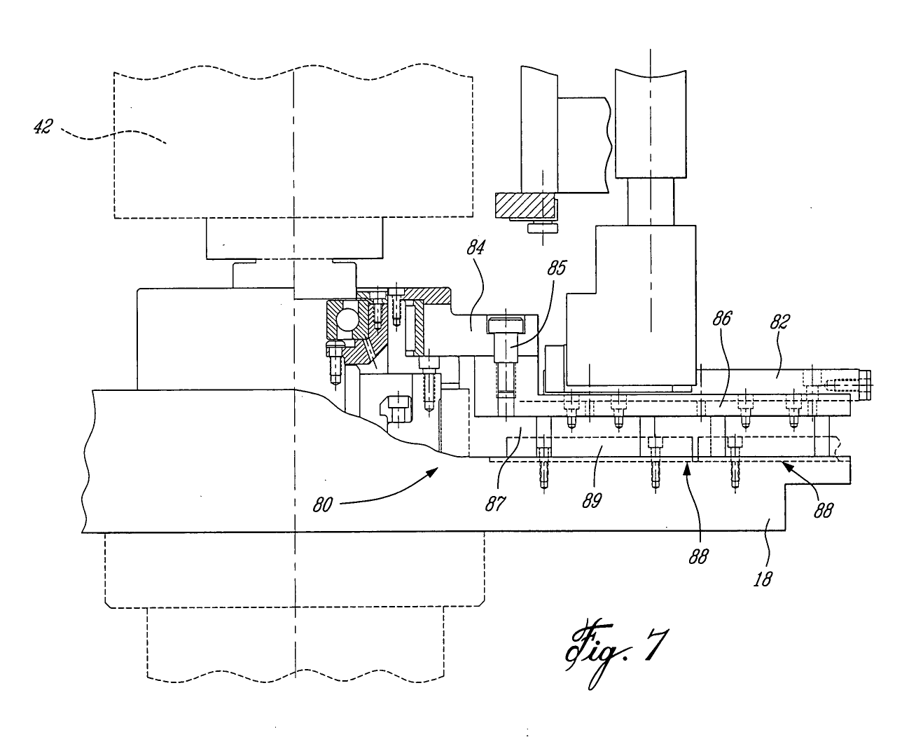

Now referring particularly to FIGS. 6 and 7, it is seen that after installing the cylinders, an enclosed doctor blade 48 is mounted against the anilox cylinder 42 for providing a controlled quantity of ink thereto. Enclosed doctor blades are also referred to as chambered doctor blades, and are preferred for use with the present invention because they offer both the ink providing and excess ink removing functions of the metering roller and doctor blade combination within a single body. It was seen that the ink cylinder is disengaged from the printing cylinder 14 at shut-down. In flexographic printing mode 40, the anilox roller must be fed ink in a regular manner even after machine shutdown to keep the ink from drying within the small cells defined within its surface. It has been found easier to provide mobility to the one body of the enclosed doctor blade 48, than to provide a mechanism for displacing metering roller and doctor blade separately. The preferred enclosed doctor blade 48 used in accordance with the preferred embodiment is the Model 88 chambered doctor blade manufactured by Printco™. Other means for providing ink to the anilox cylinder may alternatively be chosen.

Furthermore, the enclosed doctor blade 48 must preferably be adapted to fast and easy positioning with respect to cylinders of various sizes. The preferred enclosed doctor blade 48 is mounted to each press side at each end via a preferred mounting assembly 80. Further, each opposed mounting assembly 80 includes a diameter adjustment linear positioning guide 82, oriented radially with respect to the anilox cylinder 42, which receives each end of the enclosed doctor blade. Once thus received, the enclosed doctor blade 48 is displaceable along the positioning guides 82 and can therefore be positioned into abutment with anilox cylinders of various sizes. The enclosed doctor blade 48 is “slid” into abutment with the anilox cylinder of the chosen diameter, and then locked into place for operation. If changing cylinder size, the enclosed doctor blade 48 may be slid out of the way, and then slid back into the new position with respect to the selected diameter of anilox cylinder chosen. Any guide and locking mechanism known in the art and suitable to the application may be used.

Since it is desired that the enclosed doctor blade 48 stay in abutting engagement with the anilox cylinder 42 to keep supplying fresh ink thereto whether the latter is engaged to or disengaged from the flexographic plate cylinder 44, the preferred mounting assembly 80 has a further function as shall now be discussed. In fact, the enclosed doctor blade 48 is received onto a mounting plate 86 via the positioning guide 82 and locked into radial position as discussed above. The mounting plate is itself mounted onto the frame side 18 via two angled plate displacement guides 88. The angled plate displacement guides 88 each include a guide block 87 which is fixed to the mounting plate, as well as a guide rail 89 which is fixed to the frame side 18 in a displacement guide orientation. Hence, the guide blocks are free to slide along the guide rails, and consequently, the mounting plate is displaceable along the displacement guides 88. Each mounting plate has a first component of a pivot joint 85. As it was previously discussed, when thrown-off, the anilox cylinder 42 is actually kept in place within the bearing members 53, but the bearing members 53 are pivoted a certain distance about their off-center axis 54, which moves the anilox cylinder 42 along an arc-shaped engagement path, leading it into the disengaged position where it is no longer in contact with the flexographic plate cylinder 44. Although this arc-shaped engagement path is not linear, it is still oriented in a general or mean linear orientation, and its displacement may be decomposed in a linear and a rotational component. The plate displacement guides 88 are preferably oriented substantially in the general or mean orientation of the arc-shaped engagement path.

A linking member 84 is pivotally mounted about the anilox cylinder pivot axis 92, in a manner that the linking member follows the disengagement and engagement displacement of the anilox cylinder along the engagement path, but is free to pivot about the axis of the anilox cylinder. The linking member 84 further has a second pivot joint component at a substantially peripheral point. The second pivot joint component of the linking member 84 is assembled to the first pivot joint component of the mounting plate 86. Thence, when the anilox cylinder is displaced, the rotary component of its displacement is absorbed by the rotating movement of the linking member 84 about the anilox cylinder rotation axis 92, whereas the linear component of its displacement is transmitted to the mounting plate 86 which is pushed, or pulled along the plate displacement guides 88 by the linkage arm 84, carrying the enclosed doctor blade with it and maintaining the enclosed doctor blade in abutment with the anilox cylinder. The enclosed doctor blade being locked in position to the mounting plate on the positioning guide 82. The mounting plate 86 therefore follows the linear displacement component of the anilox cylinder 42 by displacement along the two mounting displacement guides, and the enclosed doctor blade 48, stays in its abutting position against the anilox cylinder 42 whether the latter is engaged or disengaged from the flexographic plate cylinder 44. The inverse happens when the anilox cylinder is engaged onto the flexographic plate cylinder from its disengaged position. The described mounting assembly is fit for adjusting to different sizes of cylinders and to adapt to the preferred engagement path as well as other potential alternative engagement paths that have a linear and rotary component of displacement. However, other types of mounting assemblies may alternatively be used.

As it was discussed, the ink 12 and impression 16 cylinders are thrown-off at the same time, and all cylinders stop turning at machine shutdown when operating in offset lithographic mode 20. In flexographic printing mode 40, however, the anilox cylinder 42 is thrown-off first to stop the supply of new ink to the flexographic plate cylinder 44, and then, after several rotations of the flexographic plate cylinder 42 whereby ink present on the flexographic plate 42 is removed, the impression cylinder 16 is thrown-off. In flexographic mode 40, the anilox cylinder keeps turning until it is ready to be removed or cleaned, in order for the ink not to dry thereon. For this reason, a suitable driving mechanism which permits at least a relatively slow, continuous rotation of the anilox cylinder 42 even when the rest of the printing unit is shut down is desired. The preferred driving mechanism described above has been found suitable to achieve this rotation in the preferred embodiment without further modification. Due to the preferred gearing mechanism 70 (FIG. 5) described above, the servo motor is left on and keeps driving both the anilox cylinder 42 and the flexographic plate cylinder 44 when the anilox cylinder 42 is thrown-off. The impression cylinder is preferably driven by the press main drive, and may be stopped.

For operation in flexographic printing mode 40, the impression cylinder 16 is engaged to the flexographic plate cylinder 44, for receiving a web or sheet therebetween, and the anilox cylinder 42 is engaged into contact with the flexographic plate cylinder 44 for transferring ink thereto. The transfer rollers are not engaged to the anilox cylinder 42, even though they are preferably not completely removed from the press frame 18. Instead, the enclosed doctor blade 48 abuts the anilox cylinder 42, and provides a controlled quantity of ink thereto, such that a desired layer of ink is maintained regardless of the printing pattern of the flexographic printing plate 44. The anilox cylinder 48 transfers the ink to the flexographic plate cylinder 44 by its rotary contact therewith, and the flexographic plate cylinder 44 then prints onto the web 11 or sheets.

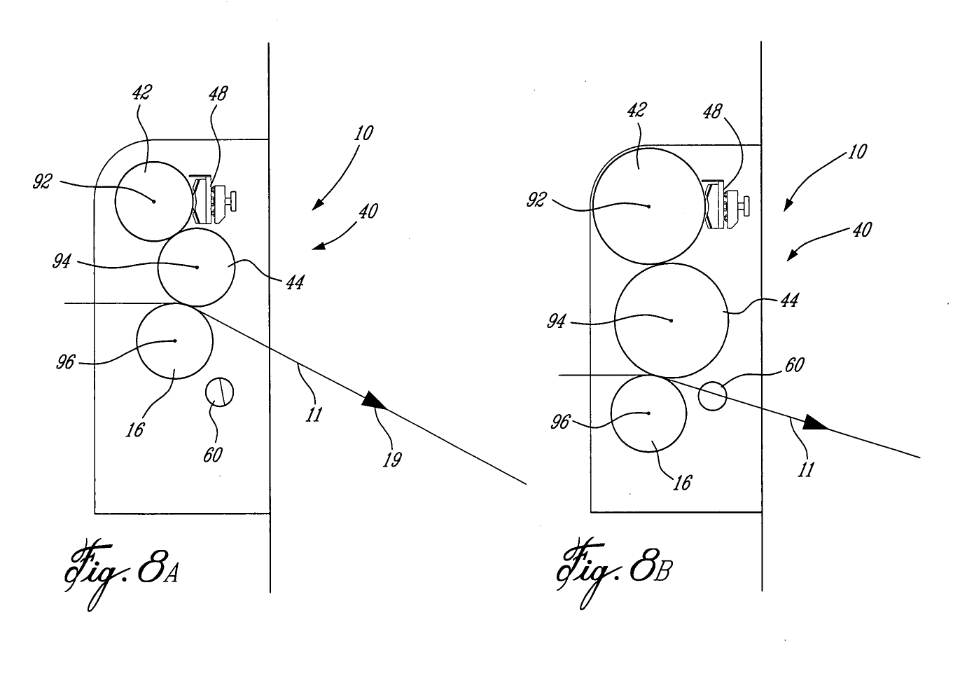

FIG. 8A illustrates the convertible printing unit 10 operating in flexographic printing mode 40 with anilox 42 and flexographic plate 44 cylinders of small diameter. It is seen that the enclosed doctor blade 48 engaged the anilox cylinder 42. FIG. 8B illustrates the flexographic printing mode 40 using cylinders 42, 44 of large diameter. The doctor blade 48 is displaceable along the linear displacement guide 82 (FIG. 6) to accommodate these two diameters of cylinders. As it was described earlier, the print cylinder is preferably displaced lengthwise in the linear slot 64 (FIGS. 3A and 3B), and the impression cylinder 16 is pivoted around the impression cylinder positioning shaft 60, to accommodate differently sized cylinders and to allow the necessary space required for large diameter cylinders. As it was described above, it is desired that the web path exiting flexographic mode 40 be angled to avoid wrapping of the web or sheets around the flexographic printing plate 40. With small cylinders, FIG. 8A, the web clears the positioning shaft 60. However, FIG. 8B shows that machining the positioning shaft 60 into a semi-circular cross-section was necessary to allow the inclined flexographic web path to clear the positioning shaft 60 when exiting the flexographic mode 40 with large cylinders. In other embodiments however, different positioning of the shaft 68, or different configuration of the displacing and engaging mechanisms may provide alternative solutions to this inconvenience.

Following the present description, switching back to lithographic mode will be readily achieved by one skilled in the art by proceeding in the inverse operation. The enclosed doctor blade 48 is first removed from the mounting assembly 80; the impression 16 and print 14 cylinders are displaced if necessary, the print 14 and ink 12 cylinders are removed, and selectively interchanged with print 14 and ink 12 cylinders corresponding to the offset lithographic mode, and having the desired diameter. The cylinders are then replaced into the proper abutting position, with the appropriate contact stripe, and the form rollers are reengaged onto the offset lithographic plate cylinder 22.

Changing only the cylinders reduces storage space requirement for providing both modes, and reduces investment costs of purchasing the components. The preferred configuration allows the use of the same driving means and gearing system for both modes, without need to change motor or gears, and the servo motor can serve as the anilox auxiliary drive for maintaining rotation of the anilox cylinder when it is thrown off. Disengaging the form rollers of the lithographic mode 20 to switch to flexographic mode 40 is made easy by the form roller adjustment system 50. Different repeat rates are possible in both modes in the preferred convertible unit by using different sizes of printing and ink cylinders. Only the sleeves of the cylinders may be changed in both modes. The arrangement provides easy access to the parts in either mode during operation, and is suited for visual inspection. The displaceable enclosed doctor blade can adapt to the throw-off sequence of the anilox cylinder. The proper throw-off sequence can be achieved in flexographic mode 40 with the roller 50 and impression 52 adjustment systems: ink cylinder disengages first, and impression cylinder disengages second. The result is a convertible printing unit that achieves conversion from offset lithographic to flexographic printing mode simply by interchanging two low-cost lightweight cylinder sleeves and installing an enclosed doctor blade 48 via a mounting system, and has been achieved in as fast as a few minutes by a skilled technician.

The embodiments of the invention described above are intended to be exemplary only. The scope of the invention is therefore intended to be limited solely by the scope of the appended claims.

What is claimed is:

1. A printing unit convertible between offset lithographic and flexographic printing modes comprising:
an ink cylinder selected from one of a lithographic plate cylinder and an anilox cylinder, said ink cylinder being removably mounted in said printing unit and having an outer surface of a diameter corresponding to a selected repeat rate and which is adapted to receive ink thereon, said ink cylinder being removable from said printing unit and interchangeable with the other of said lithographic plate cylinder and said anilox cylinder;
a print cylinder selected from one of a blanket cylinder and a flexographic plate cylinder, said print cylinder being removably mounted in said printing unit in rotatable contact with said ink cylinder and having an outer surface of said diameter which is adapted to receive ink from said ink cylinder, said print cylinder being adapted for contact with a printable substrate for printing thereon, said print cylinder being removable from said printing unit and interchangeable with the other of said blanket cylinder and said flexographic plate cylinder; and
wherein said lithographic plate cylinder and said blanket cylinder cooperate to define said offset lithographic printing mode and said anilox cylinder and said flexographic plate cylinder cooperate to define said flexographic printing mode.

2. The printing unit of claim 1 wherein said printing unit is an insert receivable within a printing press.

3. The printing unit of claim 2 wherein said printing press further comprises a dampening unit including at least one dampening form and dampening transfer rollers, and an inking unit including at least one ink form and ink transfer rollers.

4. The printing unit of claim 3 wherein at least said form rollers are displaceable within said press frame between an engaged position in contact with said ink cylinder and a disengaged position separated from said ink cylinders.

5. The printing unit of claim 1 wherein each end of said ink cylinder is displaceably mounted to said print unit via an engagement mechanism.

6. The printing unit of claim 5, wherein said ink cylinder is displaceable by said engagement mechanism along a travel path between an engaged position in rotary contact with said print cylinder and a disengaged position out of said rotary contact with said print cylinder.

7. The printing unit of claim 6 further comprising a gearing mechanism driving said ink and print cylinders, said gearing mechanism maintaining said ink and print cylinders in gear meshing engagement throughout said travel path.

8. The printing unit of claim 6 wherein each said engagement mechanism includes a displaceable bearing member rotatably supporting each end of said ink cylinder, each said bearing member being eccentrically mounted within a frame portion of said print unit.

9. The convertible printing unit of claim 6 wherein an enclosed doctor blade is mounted to said printing unit by a mounting assembly, said mounting assembly being operable to engage said enclosed doctor blade in abutting contact with said anilox cylinder when operating said printing unit in said flexographic printing mode and maintain said abutting contact throughout said travel path.

10. The convertible printing unit of claim 9 wherein said mounting assembly further comprises:
at least one mounting member engaged to a frame portion of said printing unit via at least one displacement guide, said displacement guide being orientated to correspond to said displacement path, said mounting member having a pivot joint; and
at least one linking member rotatable about an axis of said anilox cylinder, the linking member having a link pivot joint at a substantially peripheral location pivotally engaged with said mounting member at said pivot point thereon;
wherein said enclosed doctor blade is held in abutting contact with said anilox cylinder within said mounting assembly, and maintained in said abutting contact in at least both of said engaged and disengaged positions, said linking member being displaced along said displacement path by said anilox cylinder and said linking member displacing said mounting member, which carry said enclosed doctor blade, along said displacement guide.

11. The printing unit of claim 1 further comprising an impression cylinder mounted in rotatable cooperation with said print cylinder for receiving said printable substrate therebetween.

12. The printing unit of claim 11 wherein said impression cylinder is displaceable within said printing unit by an impression cylinder adjustment system to adjust a relative position between said print cylinder and said impression cylinder.

13. The printing unit of claim 11 further comprising a print cylinder displacement mechanism rotatably and displaceably receiving opposite ends of said print cylinder, and an impression cylinder displacement mechanism rotatably and displaceably receiving opposite ends of said impression cylinder, wherein said ink and said print cylinders are relatively displaceable by said respective displacement mechanisms, thereby permitting said ink and print cylinders to be interchangeable by replacements cylinders of a different diameter to provide a different repeat rate.

14. The printing unit of claim 1 further comprising a gearing mechanism driving said ink and print cylinders and coupling the rotation of said ink and print cylinders in a one to one gearing ratio.

15. The printing unit of claims 1, wherein at least one of said ink and print cylinders comprises a removable outer cylinder sleeve interchangeable with another cylinder sleeve corresponding to a different selected one of said printing modes.

16. The printing unit of claim 1 further comprising:
a print cylinder displacement mechanism displaceably receiving opposite ends of said print cylinder end;
an impression cylinder displacement mechanism displaceably receiving opposite ends of said impression cylinder;
an ink cylinder engagement mechanism displaceably receiving opposite ends of said impression cylinder;
wherein said ink and said print cylinders are interchangeable with secondary ink and print cylinders of a different diameter to provide a different repeat rate, said print cylinder and said impression cylinder being displaceable relative to a frame of said print unit via said respective displacement mechanisms to accommodate said different diameter of print and ink cylinders.

17. The printing unit as defined in claim 16, wherein said ink cylinder engagement mechanism is operable to displace said ink cylinder between an engaged position in rotary contact with said print cylinder and a disengaged position out of rotary contact with said print cylinder.

18. A printing unit convertible between at least two printing modes comprising at least two interchangeable sets of cooperating printing cylinders, a first set of said cooperating printing cylinders including a lithographic plate cylinder and a blanket cylinder and a second set of said cooperating printing cylinders including an anilox cylinder and a flexographic plate cylinder, wherein a selected one of said first and second sets is removably mounted in said printing unit with the cooperating printing cylinders thereof in rotatable contact with each other, said first set being selected to operate in an offset lithographic printing mode and said second set being selected to operate in a flexographic printing mode.

19. A method of converting a printing unit from one of a flexographic and offset lithographic actual printing mode to the other desired mode comprising:
interchanging an ink cylinder of said printing unit corresponding to said actual mode by a replacement ink cylinder corresponding to said desired mode, said ink cylinder being an anilox cylinder for said flexographic printing mode and a lithographic plate cylinder for said offset lithographic printing mode; and
interchanging a print cylinder of said printing unit corresponding to said actual mode by a replacement print cylinder corresponding to said desired mode, said print cylinder being a flexographic plate cylinder for said flexographic printing mode and a blanket cylinder for said offset lithographic printing mode.

20. An enclosed doctor blade mounting assembly for a printing unit operable in at least a flexographic printing mode in which an anilox cylinder is displaceable between an engaged and a disengaged positions along an displacement path, said mounting assembly comprising:
at least one mounting member engaged to a frame portion of said printing unit via at least one displacement guide, said displacement guide being orientated to correspond to said displacement path, said mounting member having a pivot joint; and
at least one linking member rotatable about an axis of said anilox cylinder, the linking member having a link pivot joint at a substantially peripheral location pivotally engaged with said mounting member at said pivot point thereon;
wherein said enclosed doctor blade is held in abutting contact with said anilox cylinder within said mounting assembly, and maintained in said abutting contact in at least both of said engaged and disengaged positions, said linking member being displaced along said displacement path by said anilox cylinder and said linking member displacing said mounting member, which carry said enclosed doctor blade, along said displacement guide.

21. The enclosed doctor blade mounting assembly of claim 20, wherein the mounting assembly is adjustable to enable said abutting contact of said enclosed doctor blade against anilox cylinders of different diameters, the mounting assembly further comprising:
a linear positioning guide on said mounting member oriented in a direction substantially radial to said anilox cylinder, said linear positioning guide displaceably receiving opposite ends of said enclosed doctor blade such that said enclosed doctor blade is translatable in said radial direction; and
a locking mechanism operable to releasably fix said enclosed doctor blade in a selected position corresponding to a selected diameter of said anilox cylinder.
